(19) United States
(12) Patent Application Publication
(10) Pub. No.: US 2003/0219108 A1
(43) Pub. Date: Nov. 27, 2003

(54) Telephone apparatus used for setting house code

(76) Inventor: Ikuko Sasaki, Hyogo (JP)

Correspondence Address: BURNS, DOANE, SWECKER & MATHIS, L.L.P., P. O. Box 1404, Alexandria, VA, 22313-1404, US

(21) Appl. No.: 10/315,129

(22) Filed: Dec. 10, 2002

(30) Foreign Application Priority Data
May 21, 2002 (JP) 2002-146051 (P)

(51) Int. Cl. H04M 11/00

(52) U.S. Cl. 379/102.03; 379/102.01

(57) ABSTRACT

A telephone apparatus includes: a telephone circuit unit which communicates with another telephone apparatus; a memory unit which stores a telephone number of telephone apparatus; a communication processing unit which communicates with a control target apparatus to which a house code is to be set; and a control unit which controls communication processing unit to transmit the telephone number stored in memory unit to the control target apparatus as the house code. Telephone apparatus is connected to the control target apparatus through a dedicated line inserted into a dedicated line insertion unit.

### BACKGROUND OF THE INVENTION

1. Field of the Invention

The present invention relates to a technique for setting network parameters to an electric appliance which is connected to a network with a power line used as a communication line, and more specifically to a technique for easily setting parameters to an electric appliance.

2. Description of the Background Art

There is known a system which establishes a network using a power line as a communication line, and enables electric appliances, which are connected to the power line, to transmit and receive data among them with the power line used as a LAN (Local Area Network) cable. Such a system is employed to realize a home LAN. However, since the power line has a part which is shared by adjacent homes, the electric appliances sometimes interfere with one another. Due to this, network establishment parameters which identify such electric appliances have been set while including house codes for identifying the respective homes.

Japanese Patent Laying-Open No. 62-88445 discloses a method of setting a house code as described above. According to the house code setting method disclosed therein, a subscriber telephone number in a location in which each electric appliance is installed is set to the electric appliance as a house code in a communication system to which a plurality of electric appliances which execute communications using indoor power lines.

According to this setting method, the electric appliances interfere with one another among homes which share the same columnar transformers. On the other hand, in an area to which the same area code is allocated, the same local numbers are not at all allocated to different subscribers. Since the magnitude of an area allocated the same area code is larger than that of an area to which a columnar transformer supplies power, it is possible to eliminate interference among electric appliances as much as possible by setting local numbers as house codes, respectively.

However, this publication only discloses that subscriber telephone numbers are set as respective house codes in the setting method disclosed therein. A code setter should set each subscriber telephone number as a house code using a dip switch or the like provided at each electric appliance.

### SUMMARY OF THE INVENTION

It is an object of the present invention to provide a telephone apparatus for house code setting capable of easily setting a house code.

It is another object of the present invention to provide a telephone apparatus for house code setting capable of easily setting a house code without remodeling an electric appliance to which the house code is set.

It is yet another object of the present invention to provide a telephone apparatus for house code setting capable of easily setting a house code with high safety.

It is still another object of the present invention to provide a telephone apparatus for house code setting capable of easily setting a house code with high safety in accordance with a user's demand.

A telephone apparatus for house code setting according to the present invention includes: a telephone communication circuit communicating with another telephone apparatus; a memory circuit storing a telephone number of the telephone apparatus; a communication circuit communicating with a control target apparatus to which a house code is to be set; and a control circuit connected to the memory circuit and the communication circuit, and controlling the communication circuit to transmit the telephone number stored in the memory unit, as a house code, to the control target apparatus.

The telephone number which is stored in the memory circuit can be transmitted, as a house code, to an apparatus to which the house code is set and which is controlled on the network, using the communication circuit. Since the own telephone number of the telephone apparatus (the local telephone number of the telephone apparatus) is registered in the memory circuit of the telephone apparatus, it is unnecessary to set the telephone number as the house code using a dip switch or the like. Since the telephone number is unique domestically, it is possible to set an appropriate house code. As a result, it is possible to provide a telephone apparatus for house code setting capable of easily setting a house code.

A telephone apparatus for house code setting according to another aspect of the present invention includes: a telephone communication circuit communicating with another telephone apparatus; a memory circuit storing information; a communication circuit communicating with a control target apparatus to which a house code is to be set; a processing circuit connected to the telephone communication circuit and the memory circuit, acquiring an identification code from the another telephone apparatus, and storing the identification code in the memory circuit; and a control circuit connected to the memory circuit and the communication circuit, and controlling the communication circuit to transmit the identification code stored in the memory circuit, as a house code, to the control target apparatus.

The authenticated identification code is received from a house code authentication server computer by the telephone communication circuit based on, for example, a user's demand. The received identification code can be transmitted to an apparatus to which an house code is set and which is controlled, using the communication circuit. With this configuration, since the identification code which is received using the telephone communication circuit is registered in the memory circuit in the telephone apparatus, it is unnecessary to set the house code using a dip switch or the like. As a result, it is possible to provide a telephone apparatus for house code setting capable of easily setting a house code as desired by the user.

More preferably, the telephone apparatus for house code setting further includes a telephone control circuit controlling the telephone communication circuit to transmit an identification code inputted by a user and desired by the user to the another apparatus. The processing circuit includes a circuit which acquires an identification code authenticated by the another apparatus based on the identification code inputted by the user, from the another telephone apparatus, and which stores the acquired identification code in the memory circuit.

The authenticated identification code is received from a house code authentication server computer by the telephone communication circuit based on a user's demand inputted by a user. The received identification code can be transmitted to an apparatus to which an house code is set and which is controlled, using the communication circuit. With this configuration, if the house code is desired to be changed to resist the invasion of a hacker or the like into a home LAN, the identification code which is received using the telephone communication circuit is registered in the memory circuit in the telephone apparatus. Therefore, it is possible to easily change the house code. As a result, it is possible to provide a telephone apparatus for house code setting capable of easily setting a house code as a user desires.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an outside view of a house code setting system according to a first embodiment of the present invention;

FIG. 2 is a control block diagram of a telephone apparatus shown in FIG. 1;

FIG. 3 is a control block diagram of an electric appliance shown in FIG. 1;

FIG. 4 is a view showing an identification code for identifying an electric appliance;

FIG. 5 is a flowchart showing a control structure of a processing program executed by the house code setting system according to the first embodiment of the present invention;

FIG. 6 is a flowchart showing a control structure of a processing program executed by a house code setting system according to a modification of the first embodiment of the present invention;

FIG. 7 is an outside view of a house code setting system according to a second embodiment of the present invention;

FIG. 8 is a control block diagram of a telephone apparatus shown in FIG. 7;

FIG. 9 is a control block diagram of an electric appliance shown in FIG. 7;

FIG. 10 is an outside view of a house code setting system according to a third embodiment of the present invention;

FIG. 11 is a control block diagram of a telephone apparatus shown in FIG. 10;

FIG. 12 is a control block diagram of an electric appliance shown in FIG. 10;

FIG. 13 is a flowchart showing a control structure of a processing program executed by a house code setting system according to the third embodiment of the present invention; and

FIG. 14 is a flowchart showing a control structure of a processing program executed by a house code setting system according to a fourth embodiment of the present invention.

### DESCRIPTION OF THE PREFERRED EMBODIMENTS

Hereinafter, embodiments of the present invention will be described with reference to the drawings. In the drawings, same components are denoted by the same reference symbols, respectively. Names and functions thereof are the same. They will not be, therefore, described repeatedly.

First Embodiment

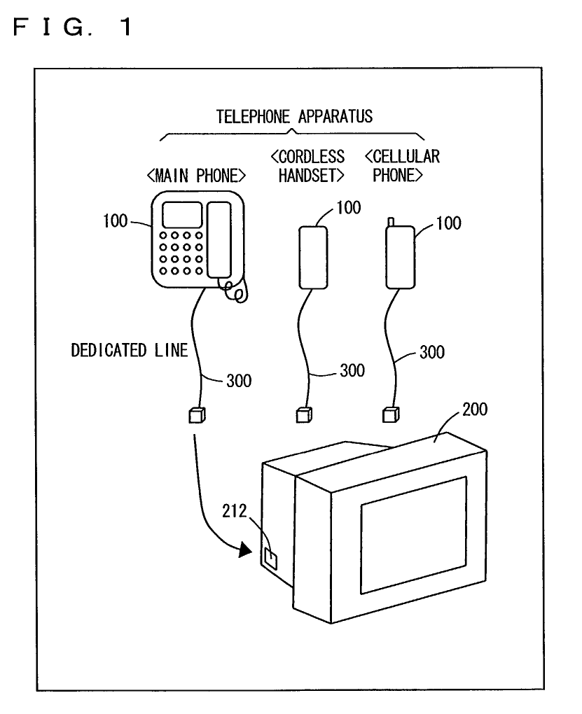

Referring to FIG. 1, the overall configuration of a house code setting system according to a first embodiment of the present inventing will be described. As shown in FIG. 1, the house code setting system includes a telephone apparatus 100 which sets a house code, and an electric appliance 200 to which the house code is set. Telephone apparatus 100 is connected to electric appliance 200 by a dedicated line 300. Telephone apparatus 100 may be a main phone of a party line, a cordless handset thereof or a cellular phone. No matter what types, telephone apparatus 100 has a dedicated line insertion unit into which dedicated line 300 is inserted. As shown in FIG. 1, electric appliance 200 is, for example, a television (TV) set. The TV set as electric appliance 200 has a dedicated line insertion unit 212 into which dedicated line 300 is inserted.

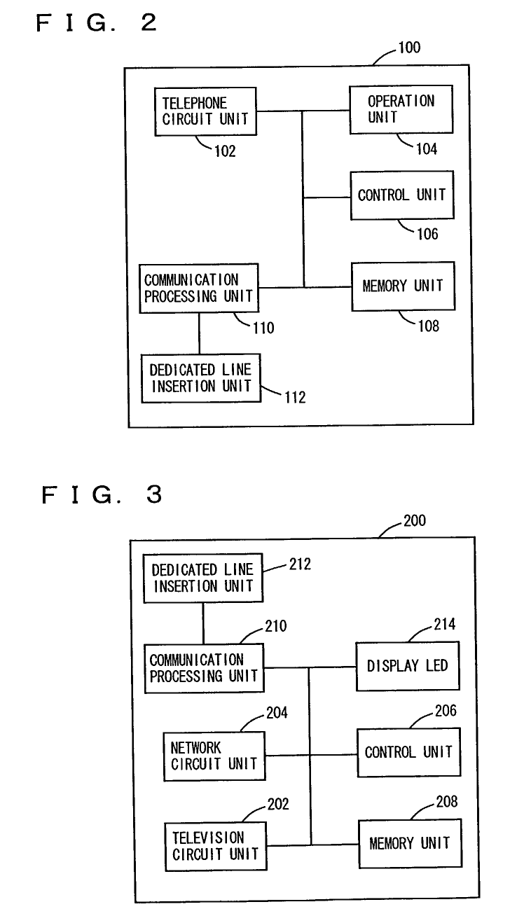

Referring to FIG. 2, the control blocks of telephone apparatus 100 shown in FIG. 1 will be described. As shown in FIG. 2, telephone apparatus 100 includes a telephone circuit unit 102 which realizes the inherent functions of telephone apparatus 100, an operation unit 104 which includes a ten key pad, a house code setting start request button and the like, a control unit 106 which controls overall telephone apparatus 100, a memory unit 108 which stores the telephone number of telephone apparatus 100 and a program executed by control unit 106, a communication processing unit 110 which processes communication with electric appliance 200 through dedicated line 300, and a dedicated line insertion unit 112 which is connected to communication processing unit 110. As shown in FIG. 2, telephone circuit unit 102, operation unit 104, control unit 106, memory unit 108 and communication processing unit 110 are connected to one another in telephone apparatus 100.

Referring to FIG. 3, the control blocks of electric appliance 200 shown in FIG. 1 will be described. As shown in FIG. 3, electric appliance 200 includes a television circuit unit 202, a network circuit unit 204 which controls electric appliance 200 over a home LAN, a control unit 206 which controls overall electric appliance 200, a memory unit 208 which stores an identification code including a house code and a program executed by control unit 206, a communication processing unit 210 which processes communication with telephone apparatus 100 through dedicated line 300, a dedicated line insertion unit 212 which is connected to communication processing unit 210, and a display LED (Light-Emitting Diode) 214 which displays a house code setting status. Television circuit unit 202, network circuit unit 204, control unit 206, memory unit 208, communication processing unit 210 and display LED 214 are connected to one another in electric appliance 200.

In the house code setting system according to the first embodiment, dedicated line insertion unit 112 of telephone apparatus 100 is connected to dedicated line insertion unit 212 of electric appliance 200 by dedicated line 300. The telephone number of telephone apparatus 100 stored in memory unit 108 of telephone apparatus 100 is transmitted as a house code to electric appliance 200.

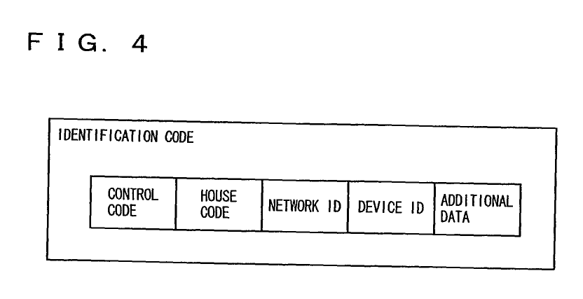

Referring to FIG. 4, the identification code which is stored in memory unit 208 of electric appliance 200 and which is a parameter for establishing a network will be described. As shown in FIG. 4, this identification code includes a control code, a house code, a network code ID (identification), a device ID, and additional data. In this embodiment, the house code shown in FIG. 4 corresponds to the telephone number which is registered for the user of the electric appliance.

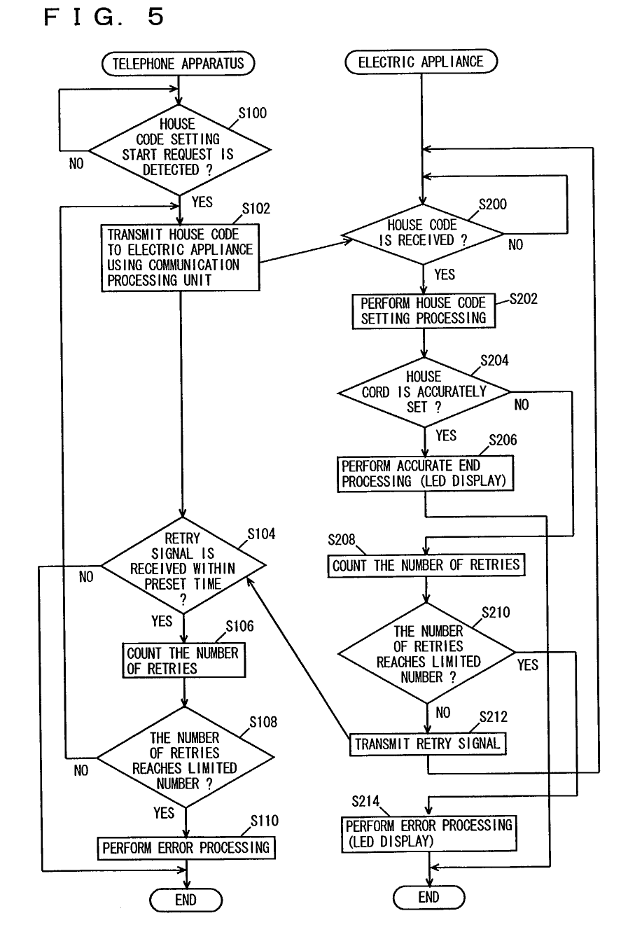

Referring to FIG. 5, the control structure of the program executed by telephone apparatus 100 and electric appliance 200 of the house code setting system according to the present embodiment will be described.

In step (abbreviated as “S” hereinafter) 100, control unit 106 of telephone apparatus 100 determines whether a house code setting start request has been detected. This determination is made based on information which is inputted from operation unit 104. If the house code setting start request is detected (“YES” in S100), the processing advances to S102. If not detected (“NO” in S100), the processing returns to S100 in which telephone apparatus 100 waits until the house code setting request is detected.

In S102, control unit 106 transmits a house code to electric appliance 200 using communication processing unit 110.

In S104, control unit 106 determines whether a retry signal has been received within preset time after the house code is transmitted to electric appliance 200. If the retry signal is received within the preset time (“YES” in S104), the processing advances to S106. If not (“NO” in S104), this processing is ended.

In S106, control unit 106 counts the number of retries. In S108, control unit 106 determines whether the number of retries reaches a limited number. If the number of retries reaches the limited number (“YES” in S108), the processing advances to S110. If not (“NO” in S108), the processing returns to S102 and the house code is retransmitted to electric appliance 200.

In S110, control unit 106 executes an error processing. At this moment, the indication of error generation or the like appears on the display unit (not shown) of telephone apparatus 100.

In S200, control unit 206 of electric appliance 200 determines whether electric appliance 200 has received the house code from telephone apparatus 100. If electric appliance 200 is received the house code from telephone apparatus 100 (“YES” in S200), the processing advances to S202. If not (“NO” in S200), the processing returns to S200 in which electric appliance 200 waits until receiving the house code from telephone apparatus 100.

In S202, control unit 206 performs a house code setting processing. This setting processing is a processing which incorporates the received house code (telephone number stored in telephone apparatus 100) into the identification code and stores the house code at a predetermined address of memory unit 208 in accordance with the format of the identification code shown in FIG. 4. In S204, control unit 206 determines whether the house code has been accurately set. If the house code can be accurately set (“YES” in S204), the processing advances to S206. If not (“NO” in S204), the processing advances to S208.

In S206, control unit 206 performs an accurate end processing. At this time, control unit 206 controls display LED 214 to display the indication of the accurate end of the processing. This processing is then ended.

In S208, control unit 206 counts the number of retries. In S210, control unit 206 determines whether the number of retries reaches a limited number. If the number of retries reaches the limited number (“YES“in S210), the processing advances to S214. If not (“NO” in S210), the processing advances to S212.

In S212, control unit 206 transmits a retry signal to telephone apparatus 100. The processing then returns to S200.

In S214, control unit 206 performs an error processing. At this time, control unit 206 controls display LED 214 to display the indication of error generation.

The operation of the house code setting system according to the present embodiment based on the above described structure and flowchart will be described.

If the user depresses the house code setting start request button of operation unit 104 of telephone apparatus 100 (“YES” in S100), the house code is transmitted to electric appliance 200 through dedicated line 300 using communication processing unit 110 of telephone apparatus 100 (in S102).

On electric appliance 200 side, if receiving the house code (“YES” in S200), electric appliance 200 executes a house code setting processing (in S202). If the house code is accurately set (“YES” in S204), an accurate end processing is performed (in S206).

If the house code setting is not accurately made (“NO” in S204), the number retries are counted (in S208). Until the number of retries reaches the limited number (“NO” in S210), the retry signal is transmitted from electric appliance 200 to telephone apparatus 100 (in S212).

On telephone apparatus 100 side, if receiving the retry signal within the preset time after the house code is transmitted to electric appliance 200 using communication processing unit 110 (“YES” in S104), the number of retries are counted (in S106). Before the number of retries reaches the limited number (“NO” in S108), the house code is retransmitted to electric appliance 200 using communication processing unit 110 (in S102).

Such a processing is performed once or repeatedly performed until the number of retries reaches the limited number, whereby the house code is set.

As described above, according to the house code setting system in the first embodiment, the telephone number of the telephone apparatus stored in the telephone apparatus is transmitted as a house code to the electric appliance. On the electric appliance side, the telephone number received from the telephone apparatus is incorporated, as the house code, into the identification code, and stored in the memory unit. With this configuration, it is possible to provide a telephone apparatus for house code setting capable of easily setting a house code without setting the house code using a dip switch or the like.

Modification of First Embodiment

Hereinafter, a house code setting system according to a modification of the first embodiment of the present invention will be described. It is noted that a telephone apparatus and an electric appliance in the present modification are equal in hardware configuration to those of the house code setting system in the first embodiment, respectively. Therefore, they will not be described in detail herein repeatedly.

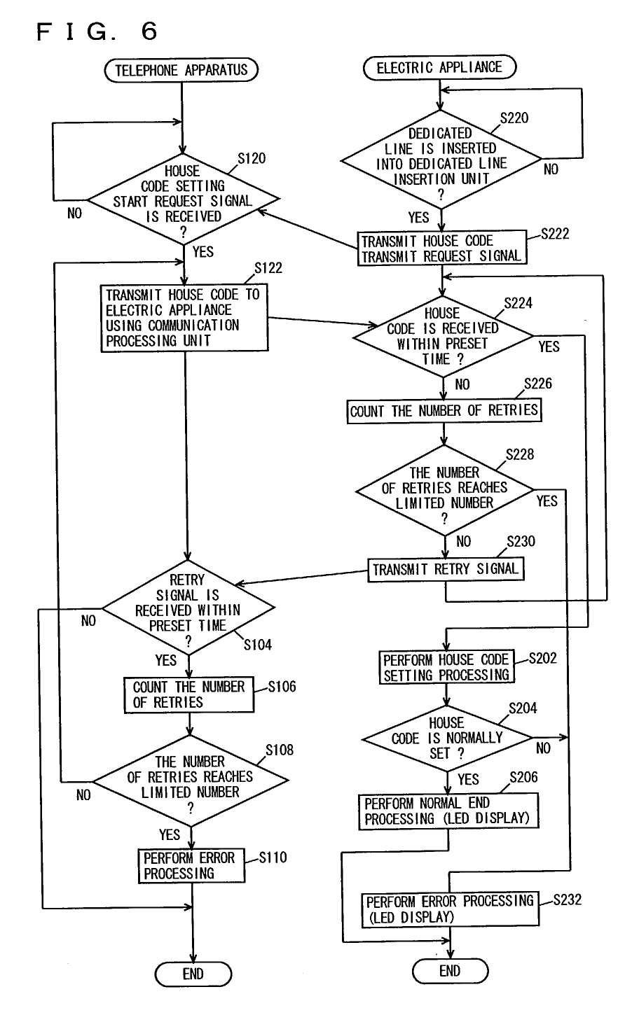

Referring to FIG. 6, the control structure of a program executed by telephone apparatus 100 and electric appliance 200 of the house code setting system in the present modification will be described. In a flowchart shown in FIG. 6, same processings as those in the flowchart shown in FIG. 5 are denoted by the same step numbers, respectively. Their processings are the same. They will not be, therefore, repeatedly described herein in detail.

In S120, control unit 106 of telephone apparatus 100 determines whether telephone apparatus 100 has received a house code transmit request signal from electric appliance 200. If having received the house code transmit request signal (“YES” in S120), the processing advances to S122. If not (“NO” in S120), the processing returns to S120 in which telephone apparatus 100 waits until receiving the house code transmit request signal from electric appliance 200. In S122, control unit 106 transmits the house code to electric appliance 200 using communication processing unit 110.

In S220, control unit 206 of electric appliance 200 determines whether dedicated line 300 has been inserted into dedicated line insertion unit 212. If dedicated line 300 is inserted into dedicated line insertion unit 212 (“YES” in S220), the processing advances to S222. If not (“NO” in S220), the processing returns to S220 in which electric appliance 200 waits until dedicated line 300 is inserted into dedicated line insertion unit 212.

In S222, control unit 206 transmits the house code transmit request signal to telephone apparatus 100. In S224, control unit 206 determines whether electric appliance 206 has received the house code from telephone apparatus 100 within preset time after the house code transmit request signal is transmitted. If the house code is received within the preset time (“YES” in S224), the processing advances to S202. If not (“NO” in S224), the processing advances to S226.

In S226, control unit 206 counts the number of retries. In S228, control unit 206 determines whether the number of retries has reached a limited number. If the number of retries reaches the limited number (“YES” in S228), the processing advances to S223. If not (“NO” in S228), the processing advances to S230.

In S230, control unit 206 transmits a retry signal to telephone apparatus 100. The processing then returns to S224.

In S232, control unit 206 controls display LED 214 to display the indication of error generation. At this time, display LED 214 is controlled to display the indication of the error generation so as to be able to make distinction between the error generation due to lack of receiving the house code from telephone apparatus 100 and that due to inability to accurately set the house code.

The operations of the house code setting system according to this modification based on the above described structure and flowchart will be described.

If dedicated line 300 is inserted into dedicated line insertion unit 212 of electric appliance 200 (“YES” in S220), electric appliance 200 transmits the house code transmit request signal to telephone apparatus 100 (in S222).

On telephone apparatus 100 side, if receiving the house code transmit request signal from electric appliance 200 (“YES” in S120), the house code is transmitted to electric appliance 200 using communication processing unit 110 (S122).

On electric appliance 200 side, if receiving the house code from telephone apparatus 100 within the preset time after the house code transmit request signal is transmitted to telephone apparatus 100 (“YES” in S224), a house code setting processing is executed (in S202). If a house code setting is accurately made (“YES” in S204), an accurate end processing is executed (S206). If not receiving the house code within the preset time after transmission of the house code transmit request signal (“NO” in S224), the number of retries is counted (in S226). If the number of retries does not reach a limit number (“NO” in S228), the retry signal is transmitted to telephone apparatus 100 until the number of retries reaches a limit number (in S230).

On telephone apparatus 100 side, if the retry signal is received to electric appliance 200 within the preset time after transmission of the house code (“YES” in S104), the number of retries is counted (in S106). If the number of retries does not reach a limit number (“NO” in S228), The house code is retransmitted to electric appliance 200 using communication processing unit 110 until the number of retries reaches a limit number (in S122).

On electric appliance 200 side, the house setting processing is executed (in S202). If the accurate house code setting is made (“YES” in S204), the accurate end processing is executed. As a result of the house code setting processing, if the accurate house code setting is not made (“NO” in S204), an error processing is executed.

As described above, according to the house code setting system in the modification of the first embodiment, the electric appliance itself detects that the dedicated line has been inserted into the electric appliance and executes a house code transmit request to the telephone apparatus. It is thereby possible to further easily setting the house code to the electric appliance compared with the house code setting system in the first embodiment.

Second Embodiment

A house code setting system according to the second embodiment will be described hereinafter.

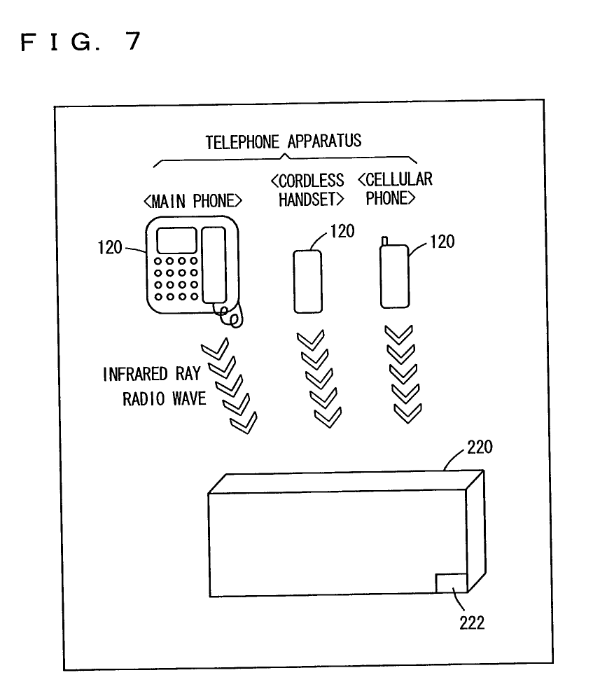

As shown in FIG. 7, differently from the house code setting system according to the first embodiment, the house code setting system according to this embodiment transmits a house code from a telephone apparatus to an electric appliance not by dedicated line 300 but by an infrared ray or a radio wave.

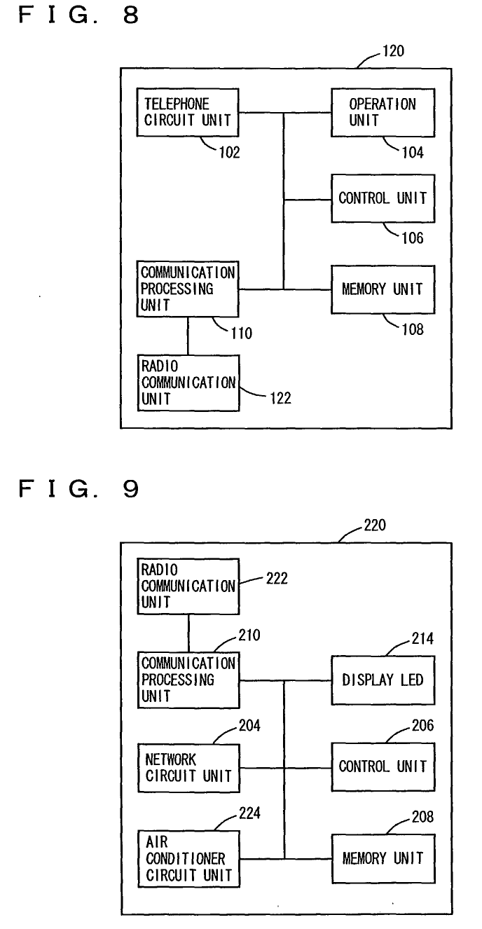

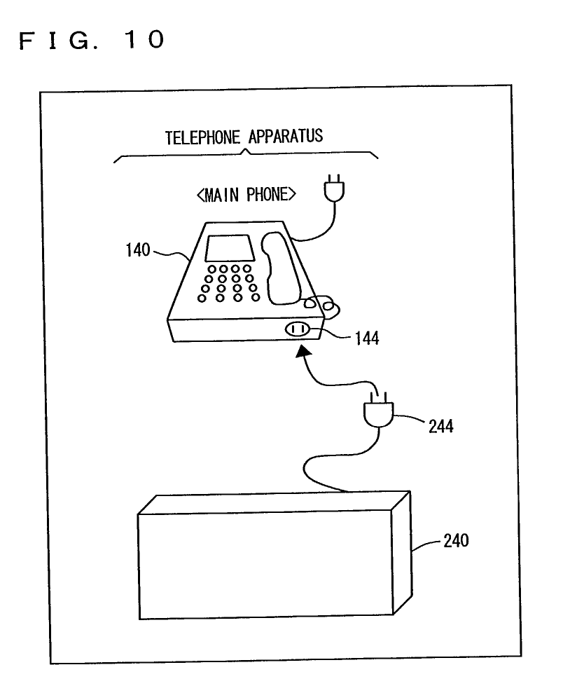

FIG. 8 shows the control blocks of a telephone apparatus 120 shown in FIG. 7 and FIG. 9 shows the control blocks of an electric appliance 220 shown in FIG. 7. In the control blocks shown in FIGS. 8 and 9, the same blocks as those shown in FIGS. 2 and 3 are denoted by the same reference symbols as those in FIGS. 2 and 3, respectively. The control blocks are the same in function, respectively. They will not be, therefore, described herein in detail.

Referring to FIG. 8, telephone apparatus 120 includes a radio communication unit 122 which is connected to communication processing unit 110. Referring to FIG. 9, electric appliance 220 includes a radio communication unit 222 which is connected to communication processing unit 210. Radio communication unit 122 of telephone apparatus 120 holds communication with radio communication unit 222 of electric appliance 220 using an infrared ray or a radio wave and a house code is transmitted from telephone apparatus 120 to electric appliance 220. Further, as shown in FIG. 9, while electric appliance 200 according to the first embodiment is a TV set, electric appliance 220 according to the second embodiment is an air conditioner. Due to this, electric appliance 220 includes an air conditioner circuit unit 224.

The flowchart of a program executed by telephone apparatus 120 and electric appliance 220 which include the above described structures, respectively, is the same as the flowchart (FIG. 5) of the program executed by the telephone apparatus and the electric appliance of the house code setting system according to the preceding first embodiment. Therefore, the flowchart will not be repeatedly described herein in detail.

As described above, according to the house code setting system of this embodiment, the house code is transmitted from the telephone apparatus to the electric appliance not by a wire but by radio transmission, thereby making it possible to further easily setting the house code to the electric appliance.

Third Embodiment

A house code setting system according to a third embodiment of the present invention will be described hereinafter.

As shown in FIG. 10, the house code setting system according to this embodiment, differently from the house code setting systems according to the first and second embodiments, transmits a house code from a telephone apparatus 140 to an electric appliance 240 by connecting a receptacle 144 which is provided at telephone apparatus 140 to a plug 244 of electric appliance 240.

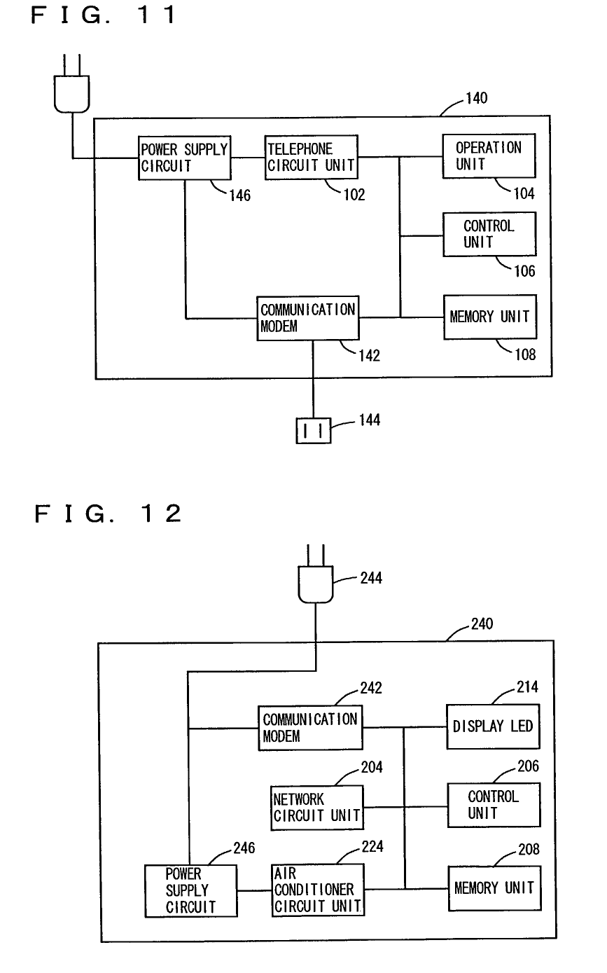

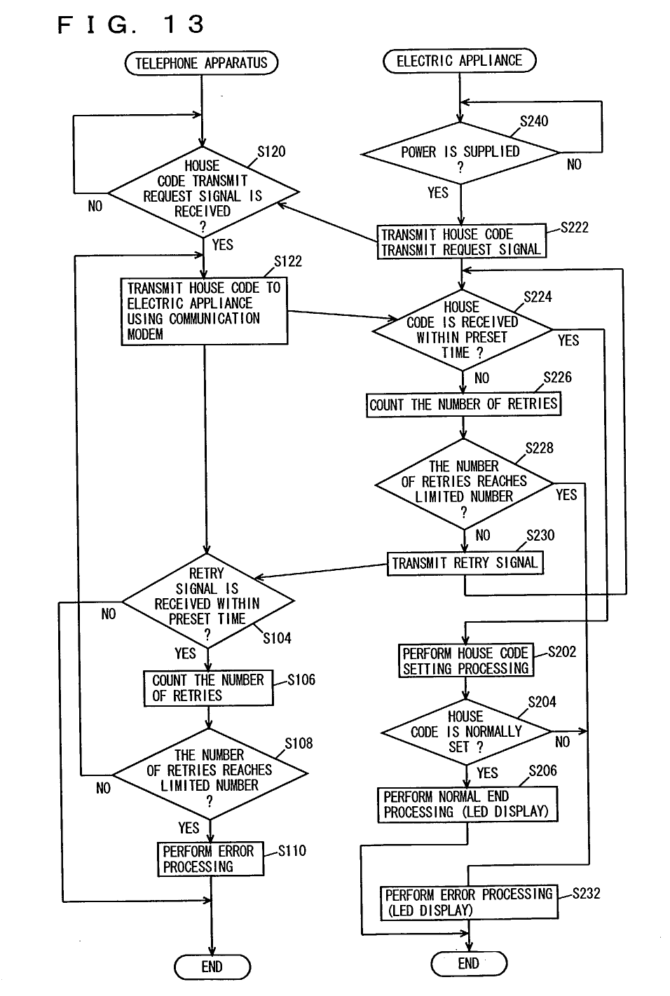

FIG. 11 shows the control blocks of telephone apparatus 140 shown in FIG. 10 and FIG. 12 shows the control blocks of electric appliance 240 shown in FIG. 10. In the control blocks shown in FIGS. 11 and 12, the same blocks as those of the telephone apparatuses and the electric appliances of the house code setting systems according to the first and second embodiments are denoted by the same reference symbols as those in the first and second embodiments, respectively. The blocks are the same in function, respectively. Therefore, they will not be repeatedly described herein in detail.

As shown in FIG. 11, telephone apparatus 140 includes a communication modem 142, receptacle 144, and a power supply circuit 146. Communication modem 142 communicates with electric appliance 240 through receptacle 144. The plug of telephone apparatus 140 is connected to power supply circuit 146 and power is thereby supplied from power supply circuit 146 to telephone circuit unit 102 and communication modem 142.

As shown in FIG. 12, electric appliance 240 includes a communication modem 242 which corresponds to communication modem 142 shown in FIG. 11, plug 244 which is inserted into receptacle 144 shown in FIG. 11, and a power supply circuit 246 which is connected to plug 244. Power supply circuit 246 supplies power to communication modem 242 and an air conditioner circuit unit 244.

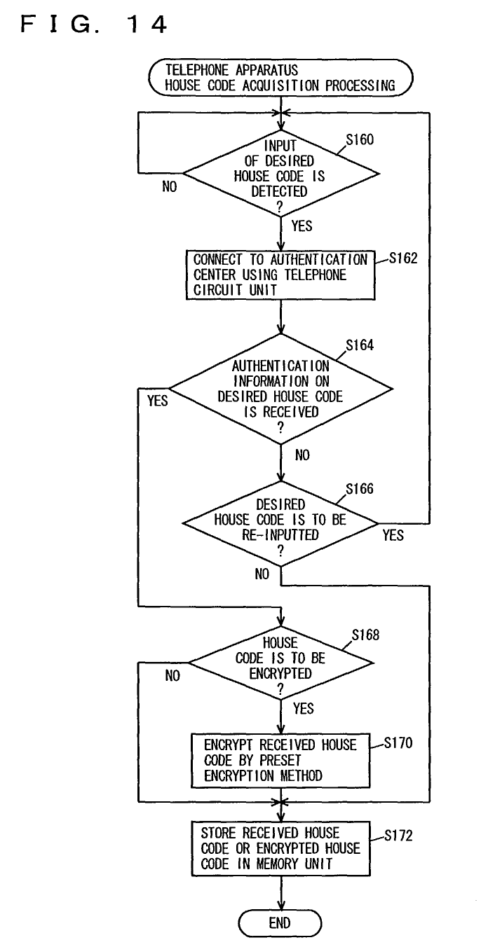

Referring to FIG. 13, the control structure of a program executed by telephone apparatus 140 and electric appliance 240 of the house code setting system according to this embodiment will be described. In a flow chart shown in FIG. 13, the same processings as those in the flow chart shown in FIG. 6 already described above are denoted by the same step numbers, respectively. They are the same as the processings denoted by the same step numbers shown in FIG. 6, respectively. Therefore, these processings will not be repeatedly described herein in detail.

In S240, control unit 206 of electric appliance 240 determines whether power is supplied from plug 244 to electric appliance 240. If power is supplied thereto (“YES” in S240), the processing advances to S222. If not (“NO” in S240), the processing returns to S240 in which electric appliance 240 waits until power is supplied to electric appliance 240 from telephone apparatus 140 through plug 244.

The operation of the house code setting system according to this embodiment based on the above described structure and flow chart will be described. If plug 244 of electric appliance 240 is inserted into receptacle 144 of telephone apparatus 140, power is supplied from telephone apparatus 140 to electric appliance 240 (“YES” in S240). Electric appliance 240 transmits a house code transmit request signal to telephone apparatus 140 (in S222).

Telephone apparatus 140 receives the house code transmit request signal from electric appliance 240 through an electric power line. At this moment, communication is executed through the electric power line using communication modem 242 of electric appliance 240 and communication modem 142 of telephone apparatus 140. Telephone apparatus 140 transmits a house code to electric appliance 240 using communication modem 142 (in S122).

If receiving the house code from telephone apparatus 140 within preset time after the house code transmit request signal is transmitted (“YES” in S224), electric appliance 240 executes a house code setting processing (in S202). If a house code setting is accurately made (“YES” in S204), an accurate end processing is executed (in S206).

If electric appliance 240 does not receive the house code from telephone apparatus 140 within the preset time after electric appliance 240 transmits the house code transmit request signal to telephone apparatus 140 (“NO” in S224), electric appliance 240 counts the number of retries (in S226). Until the number of retries reaches a limited number (“NO” in S228), a retry signal is transmitted from electric appliance 240 to telephone apparatus 140 (in S230).

On telephone apparatus 140 side, if receiving the retry signal from electric appliance 240 (“YES” in S104), telephone apparatus 140 counts the number of retries (in S106). Until the number of retries reaches a limited number (“NO” in S108), telephone apparatus 140 retransmits the house code to electric appliance 240 using communication modem 142 (in S122).

As described above, according to the house code setting system in this embodiment, the telephone apparatus and the electric appliance are connected to each other through the electric power line and the house code transmit request signal is transmitted from the telephone apparatus to the electric appliance using the electric power line and the communication modems. Based on this house code transmit request signal, the house code is transmitted from the telephone apparatus to the electric appliance. Based on the house code (telephone number) thus received, the electric appliance sets the house code. As a result, the identification code of the electric appliance is set based on the house code transmitted from the telephone apparatus through the electric power line, it is possible to further easily setting the house code.

Fourth Embodiment

A house code setting system according to a fourth embodiment of the present invention will be described hereinafter. It is noted that the telephone apparatus and the electric appliance of the house code setting system according to this embodiment are equal in hardware configuration to those of the house code setting system according to one of the preceding first to third embodiments. Therefore, they will not be repeatedly described herein in detail.

The telephone apparatus of the house code setting system according to this embodiment is connected to an authentication center which authenticates a house code using telephone circuit unit 102, receives house code authentication information from the authentication center and stores the house code to be transmitted to the electric appliance based on the authentication information.

Referring to FIG. 14, the control structure of a program executed by the telephone apparatus of the house code setting system according to this embodiment will be described.

In S160, control unit 106 of the telephone apparatus determines whether the input of a desired house code is detected. This determination is made based on information inputted from operation unit 104 by the user of the telephone apparatus. If it is detected that the desired house code has been inputted (“YES” in S160), the processing advances to S162. If not (“NO” in S160), the processing returns to S160 and the telephone apparatus waits until it is detected that the desired house code is inputted.

In S162, control unit 106 is connected to the authentication center using telephone circuit unit 102. This authentication center determines whether the desired house code transmitted from the telephone apparatus is overlapped with an already registered house code. If not overlapped, the authentication information is transmitted to the telephone apparatus.

In S164, control unit 106 determines whether the authentication information on the desired house code has been received. If the authentication information on the desired house code is received (“YES” in S164), the processing advances to S168. If not (“NO” in S164), the processing advances to S166.

In S166, control unit 106 determines whether the desired house code is to be re-inputted. This determination is made based on the information which the user of the telephone apparatus inputs using operation unit 104. If the desired house code is to be re-inputted (“YES” in S166), the processing returns to S160. If not (“NO” in S166), the processing advances to S172.

In S168, control unit 106 determines whether the house code is to be encrypted. This determination is made based on the information which is inputted from operation unit 104 in advance. If the house code is to be encrypted (“YES” in S168), the processing advances to S170. If not (“NO” in S168), the processing advances to S172.

In S170, control unit 106 encrypts the received house code by a preset encryption method. In S172, control unit 106 stores the received house code or the encrypted house code in memory unit 108.

The operation of the house code setting system according to this embodiment based on the above described structure and flow chart will be described.

If the user of the telephone apparatus inputs a desired house code from operation unit 104 (“YES” in S160), the telephone apparatus is connected to the authentication center using telephone circuit unit 102 (in S162). If the telephone apparatus receives authentication information on the desired house code from the authentication center (“YES” in S164), it is determined whether the house code is to be encrypted (in S168). If the house code is to be encrypted (“YES” in S168), the received house code is encrypted by a preset encryption method (in S170). The received house code or encrypted house code is stored in the memory unit 108 (in S172).

The house code which is stored in memory unit 108 is subjected to the processings described above in the house code setting system according to one of the first to third embodiments and then transmitted to the electric appliance.

If the telephone apparatus does not receive the authentication information on the desired house code (“NO” in S164), this means that the desired house code is already registered and it is, therefore, determined whether the desired house code is to be re-inputted (in S166). If the desired house code is to be re-inputted (“YES” in S166), it is determined whether the input of the desired house code has been detected (in S160). If it is detected that the desired house code has been inputted, the telephone apparatus is reconnected to the authentication center using telephone circuit unit 102 (in S162).

As described above, according to the house code setting system in this embodiment, the house code setting can be made if the house code is not overlapped with the already registered house code. As a result, if the telephone number is set as the house code and a hacker or the like invades the home LAN, for example, it is possible to suppress possible damage done by the invasion by easily changing the house code. Furthermore, if the house code is encrypted, it is possible suppress the occasion of invasion by a hacker or the like.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A telephone apparatus for house code setting comprising:
a telephone communication circuit communicating with another telephone apparatus;
a memory circuit storing a telephone number of said telephone apparatus;
a communication circuit communicating with a control target apparatus to which a house code is to be set; and
a control circuit connected to said memory circuit and said communication circuit, and controlling said communication circuit to transmit the telephone number stored in said memory unit, as a house code, to said control target apparatus.

2. The telephone apparatus for house code setting according to claim 1, wherein
said communication circuit includes a circuit connecting said telephone apparatus for house code setting to said control target apparatus by a wire to thereby establish communication.

3. The telephone apparatus for house code setting according to claim 1, wherein
said communication circuit includes a circuit connecting said telephone apparatus for house code setting to said control target apparatus by radio transmission to thereby establish communication.

4. The house code setting telephone apparatus according to claim 1, wherein
said communication circuit includes a circuit connecting said telephone apparatus for house code setting to said control target apparatus by a power line to thereby establish communication.

5. A telephone apparatus for house code setting comprising:
a telephone communication circuit communicating with another telephone apparatus;
a memory circuit storing information;
a communication circuit communicating with a control target apparatus to which a house code is to be set;
a processing circuit connected to said telephone communication circuit and said memory circuit, acquiring an identification code from said another telephone apparatus, and storing the identification code in said memory circuit; and
a control circuit connected to said memory circuit and said communication circuit, and controlling said communication circuit to transmit the identification code stored in said memory circuit, as a house code, to said control target apparatus.

6. The telephone apparatus for house code setting according to claim 5, further comprising
a telephone control circuit controlling said telephone communication circuit to transmit an identification code inputted by a user and desired by said user to said another apparatus, wherein
said processing circuit includes a circuit acquiring an identification code authenticated by said another apparatus based on the identification code inputted by said user, from said another telephone apparatus, and storing the acquired identification code in said memory circuit.
